(19) United States
(12) Patent Application Publication
(10) Pub. No.: US 2025/0041719 A1
(43) Pub. Date: Feb. 6, 2025

(54) SPECIAL EFFECT DISPLAY METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Ye KUANG, Shenzhen (CN)

(21) Appl. No.: 18/921,240

(22) Filed: Oct. 21, 2024

Related U.S. Application Data
(63) Continuation of application No. PCT/CN2023/124953, filed on Oct. 17, 2023.

(30) Foreign Application Priority Data
Nov. 15, 2022 (CN) 202211427552.1

(51) Int. Cl. A63F 13/48; A63F 13/52; A63F 13/533

(52) U.S. Cl. CPC A63F 13/48; A63F 13/52; A63F 13/533; A63F 2300/308

(57) ABSTRACT

A special effect display method includes: displaying a preparation interface of a first round of a game match, multiple contestants in the game match being displayed in the preparation interface; determining an interactive opponent of the first round from the multiple contestants in response to the first round being an opponent round which is an interactive round between the contestants; displaying, in response to that the preparation interface does not contain an obstruction, a prompt special effect for the interactive opponent, the prompt special effect prompting the matched interactive opponent in the first round, and the obstruction referring to an interface element capable of shielding the prompt special effect; and in response to a trigger operation on the prompt special effect switching from the preparation interface to an observation interface for the interactive opponent in a second round which is observed from a perspective of the interactive opponent.

### CROSS-REFERENCES TO RELATED APPLICATIONS

This application is a continuation application of PCT Patent Application No. PCT/CN2023/124953, filed on Oct. 17, 2023, which claims priority to Chinese Patent Application No. 202211427552.1, filed on Nov. 15, 2022 and entitled “SPECIAL EFFECT DISPLAY METHOD AND APPARATUS, ELECTRONIC DEVICE, AND STORAGE MEDIUM”, both of which are incorporated herein by reference in their entirety.

### FIELD OF THE TECHNOLOGY

The present disclosure relates to the field of computer technologies, and in particular, to a special effect display method and apparatus, an electronic device, and a storage medium.

### BACKGROUND OF THE DISCLOSURE

Auto chess is a new type of chess game. A game match is usually divided into several rounds. In each round, two parties of the game select field objects from owned virtual objects (usually referred to as “chess pieces”). After the field objects are placed on a gameboard, a game application can automatically control the field objects of the two parties to interact with each other and output an interaction result.

A preparation phase is usually set before the start of a round, so that a player can extract or purchase new virtual objects conveniently, adjust the lineup or stance of the field objects of this round, or equip the field objects. There may be a restraint relationship between field objects of a specific lineup. To improve the game strategy, the player needs to observe requirements of the opponent lineup, that is, it is critical about how to effectively prompt the opponent of this round in the preparation stage in the auto chess game.

### SUMMARY

Embodiments of the present disclosure provide a special effect display method and apparatus, an electronic device, and a storage medium, so as to provide an enhanced display manner of an interactive opponent in any round of a game match, thereby improving human-computer interaction efficiency. The technical solutions are as follows:

According to one aspect, a special effect display method is provided, where the method is performed by an electronic device, and the method includes: displaying a preparation interface of a first round of a game match, multiple contestants in the game match being displayed in the preparation interface; determining an interactive opponent of the first round from the multiple contestants in response to the first round being an opponent round, the opponent round being an interactive round between the contestants; displaying, in response to that the preparation interface does not contain an obstruction, a prompt special effect for the interactive opponent, the prompt special effect being configured for prompting the matched interactive opponent in the first round, and the obstruction referring to an interface element capable of shielding the prompt special effect; and switching from the preparation interface to an observation interface for the interactive opponent in a second round in response to a trigger operation on the prompt special effect, the second round being observed from a perspective of the interactive opponent in the observation interface.

According to one aspect, a special effect display apparatus is provided, where the apparatus includes: an interface display module, configured to display a preparation interface of a first round of a game match, multiple contestants in the game match being displayed in the preparation interface; an opponent determining module, configured to determine an interactive opponent of the first round from the multiple contestants in response to the first round being an opponent round, the opponent round being an interactive round between the contestants; a special effect display module, configured to: display, in response to that the preparation interface does not contain an obstruction, a prompt special effect for the interactive opponent, the prompt special effect being configured for prompting the matched interactive opponent in the first round, and the obstruction referring to an interface element capable of shielding the prompt special effect; and an interface switching module, configured to switch from the preparation interface to an observation interface for the interactive opponent in a second round in response to a trigger operation on the prompt special effect, the second round being observed from a perspective of the interactive opponent in the observation interface.

According to one aspect, an electronic device is provided, where the electronic device includes one or more processors and one or more memories, the one or more memories store at least one computer program, and the at least one computer program is loaded and executed by the one or more processors to implement the special effect display method in any one of the foregoing possible implementations.

According to one aspect, a non-transitory computer readable storage medium is provided, where the computer readable storage medium stores at least one computer program, and the at least one computer program is loaded and executed by a processor to implement the special effect display method in any one of the foregoing possible implementations.

The technical solutions provided in the embodiments of the present disclosure produce at least the following beneficial effects:
In a preparation phase of an opponent round, because both parties involved are contestants participating in a game match, a terminal first detects whether there is an obstruction in a preparation interface. Only in response to that there is no obstruction, the terminal plays a prompt special effect for the interactive opponent, so that a user can quickly enter, by using the prompt special effect, an observation interface in a completed or ongoing round of the interactive opponent. On one hand, this prompt special effect is used for emphasizing the matched interactive opponent. On the other hand, by using detection logic of the obstruction, the user can avoid missing the prompt special effect because the prompt special effect is shielded, and avoid forgetting or missing this very important strategy prompt of the interactive opponent. In addition, in a playback process of the prompt special effect, the user can enter the observation interface at any time by using the prompt special effect, thereby shortening an operation link for the user to enter the observation interface, and improving human-computer interaction efficiency.

### BRIEF DESCRIPTION OF THE DRAWINGS

To describe the technical solutions in the embodiments of the present disclosure more clearly, the following briefly describes the accompanying drawings required for describing the embodiments.

FIG. 1 is a schematic diagram of an implementation environment of a special effect display method according to an embodiment of the present disclosure.

FIG. 2 is a flowchart of a special effect display method according to an embodiment of the present disclosure.

FIG. 3 is a flowchart of a special effect display method according to an embodiment of the present disclosure.

FIG. 4 is a schematic diagram of a preparation interface that includes a function pop-up window according to an embodiment of the present disclosure.

FIG. 5 is a playback flowchart of a prompt special effect according to an embodiment of the present disclosure.

FIG. 6 is a schematic diagram of a prompt special effect display process according to an embodiment of the present disclosure.

FIG. 7 is a logical flowchart of a prompt special effect display method according to an embodiment of the present disclosure.

FIG. 8 is a schematic structural diagram of a special effect display apparatus according to an embodiment of the present disclosure.

FIG. 9 is a schematic structural diagram of an electronic device according to an embodiment of the present disclosure.

### DESCRIPTION OF EMBODIMENTS

To make objectives, technical solutions, and advantages of the present disclosure clearer, the following further describes implementations of the present disclosure in detail with reference to the accompanying drawings.

In the present disclosure, the terms “first,” “second,” and the like are used for distinguishing between same items or similar items that have basically same functions and functions. “first,” “second,” and “nth” do not have logical or time sequence dependency, and a quantity and an execution sequence are not limited either.

In the present disclosure, the term “at least one” refers to one or more, and “multiple” refers to two or more. For example, multiple contestants refer to two or more contestants.

In the present disclosure, the term “including at least one of A or B” involves the following several cases: including only A, including only B, and including both A and B.

User-related information (including but not limited to device information, personal information, behavior information, and the like of a user), data (including but not limited to data used for analysis, stored data, displayed data, and the like), and a signal in the present disclosure are all licensed, approved, authorized by the user, or fully authorized by all parties when the method in the embodiments of the present disclosure is applied to a specific product or technology, and collection, use, and processing of the related information, the data, and the signal need to comply with related laws, regulations, and standards of a related country or region. For example, account attribute in ranking information involved in the present disclosure is obtained under full authorization.

First, terms involved in the embodiments of the present disclosure are briefly introduced.

Virtual environment: is a virtual environment that an application program displays (or provides) when running on a terminal. The virtual environment may be a simulated environment for a real world, may be a semi-simulated semi-virtual environment, or may be a pure virtual environment. The virtual environment may be any one of a two-dimensional virtual environment, a 2.5-dimensional virtual environment, or a three-dimensional virtual environment. This is not limited in the present disclosure. The following embodiments are described by using an example in which the virtual environment is a three-dimensional virtual environment.

Auto chess: is a new type of multi-player electronic strategy chess and card game. In auto chess, a game match is usually divided into multiple rounds. In each round, a user can match one or more field objects from owned virtual objects (for example, “chess pieces” or “hero cards”) in the current round to form a virtual object lineup of the current round, and confront with a virtual object lineup of an opponent in the current round.

For auto chess, there is a fixed quantity of contestants in a game match, and the contestants do not change in the game match. The contestants confront with each other in pairs in each round. A virtual image of a loser of the contestants in each round can be deducted by a certain virtual health value. The above process is repeated for multiple times until a virtual image of only one contestant of all contestants survives. The virtual image is different from a virtual object that can be played as a chess piece. A player has only one virtual image in a game match, but can have many virtual objects.

Further, in each round, a basic game rule is that a player can select a combination between different types of virtual objects, and place selected field objects on a gameboard of the player as chess pieces. Thereafter, a system will automatically perform confrontation with chess pieces selected by other players until finally a party that still has a chess piece surviving wins.

Gameboard: refers to an area in which auto chess is configured for preparing for and performing confrontation on a game interface, and may be any one of a two-dimensional virtual gameboard, a 2.5-dimensional virtual gameboard, or a three-dimensional virtual gameboard. This is not limited in the present disclosure. The gameboard is divided into a confrontation area and a preparation area.

The confrontation area includes several confrontation chess grids of the same size, and the confrontation chess grids are configured for placing field objects for confrontation in each round of a game match. The preparation area includes several preparation chess grids. The preparation chess grids are configured for placing candidate virtual objects. Virtual objects that are owned by a player but not yet present may be placed in the preparation chess grids. In a preparation phase before a round starts, a player may drag some virtual objects in the preparation chess grid to the confrontation chess grid, so as to adjust a virtual object lineup in this round, or may adjust a stance of each field object placed in the confrontation chess grid, to implement a preset confrontation strategy. A virtual object participates in a confrontation as a field object in this round only after being dragged from a preparation chess grid to a confrontation chess grid. If the virtual object is always placed in the preparation chess grid, the virtual object will not participate in the confrontation in the current round.

For a manner of setting a chess grid in a confrontation area, in a possible implementation, the confrontation area includes n (rows)×m (columns) confrontation chess grids, where n is an integer multiple of 2, and two adjacent rows of chess grids are aligned, or two adjacent rows of chess grids are staggered. In addition, the confrontation area is evenly divided into two parts by row, that is, an own confrontation area and an opponent confrontation area. In the preparation stage, the player can only place a chess piece on the confrontation chess grid of the own confrontation area. m is a positive integer, and both n and m are preconfigured by a technical person.

Virtual image: is the only image corresponding to a contestant in a game match. A player determines whether the player is eliminated by using a virtual health value of the virtual image. For example, when the virtual health value decreases to 0 or is less than a preset threshold, the contestant bound to the virtual image is considered as being eliminated in the game match, and the preset threshold is a value preconfigured by a technical person. In auto chess, the virtual image cannot be placed on a gameboard as a chess piece or played for confrontation in a round of a game match. The virtual image runs through each round of the game match of the contestant until the virtual image is killed and the contestant is eliminated.

Virtual object: is the minimum unit of confrontation in a virtual object lineup matched with a participant in each round of a game match. In auto chess, a virtual object can only be moved in a gameboard in a virtual environment, or is placed in a preparation area of the gameboard as a candidate virtual object, or is placed in a confrontation area of the gameboard as a chess piece. In other words, the virtual object refers to a movable object that is limited to activity on the gameboard in auto chess, and the virtual object only needs a player to control its stance before a round starts, but does not need the player to manually control the virtual object to perform intra-round confrontation, and the intra-round confrontation of the virtual object is automatically controlled by the system. The virtual object may be a virtual chess piece, a virtual character, a virtual animal, an animated character, or the like. Each virtual object has its own shape and volume in the gameboard, and occupies one chess grid of the preparation area or the confrontation area in the gameboard.

In auto chess, a player can purchase, sell, upgrade, give equipment, and enhance a virtual object to adjust or optimize a virtual object lineup. For example, the player can extract a new virtual object in a card extraction manner in a virtual store.

Game match: refers to a virtual match in which at least two contestants confront with each other in a virtual environment. Each contestant has a unique corresponding virtual image in a game match, and the virtual image does not change with a round change in the same game match. A game match includes multiple rounds. The round may be divided into an opponent round and a non-opponent round. The opponent round refers to a round in which contestants confront with each other in groups, and the non-opponent round refers to a round in which contestants do not confront with each other, for example, a jungle round in which contestants confront with a virtual wild monster, or a round in which contestants purchase some virtual trophies in a virtual store. A type of the non-opponent round is not specifically limited herein.

Preparation stage: is an important stage before start of each round in a game match of auto chess. In the preparation stage, players can perform a series of preparation operations such as store card extraction, lineup improvement, stance adjustment, equipment provision, and information obtaining. It is an important operation in adjusting the game strategy of this round.

Store card extraction: In a preparation phase before start of a round, a virtual store interface automatically pops up in a game application. A player can buy a desired chess piece in a virtual store to improve a virtual object lineup.

The following describes a system architecture in an embodiment of the present disclosure.

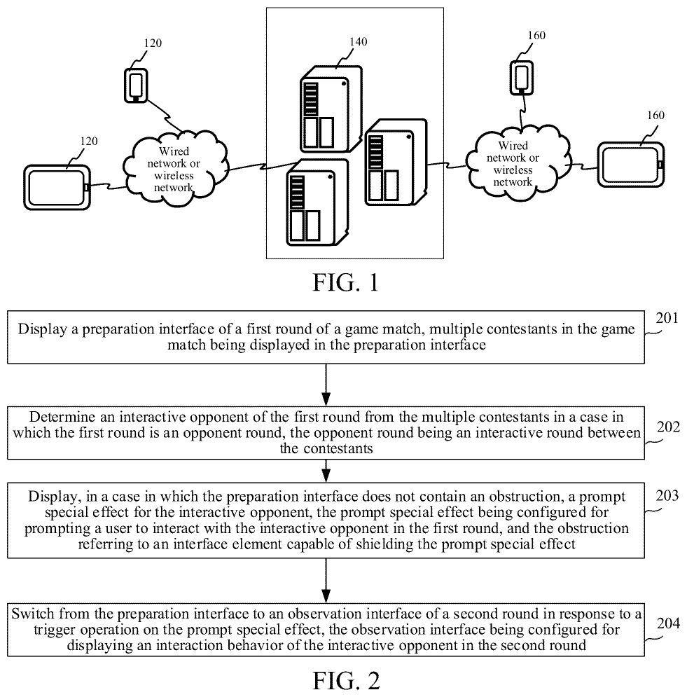

FIG. 1 is a schematic diagram of an implementation environment of a special effect display method according to an embodiment of the present disclosure. Referring to FIG. 1, the implementation environment includes: a first terminal 120, a server 140, and a second terminal 160.

The first terminal 120 installs and runs a game application that supports a virtual environment. In some embodiments, the game application includes: any one of auto chess, a multi-player strategy round chess and card game, a virtual reality application, a three-dimensional map application, or a multi-player equipment survival game. In some embodiments, the first terminal 120 is a terminal used by a first user. When the first terminal 120 runs the game application, a user interface of the game application is displayed on a screen of the first terminal 120, and an opening request is sent to the server 140 based on an opening operation performed by the first user in the user interface. The server 140 returns, to the first terminal 120, multiple contestants (including the first user itself) that are matched with a game match, and the first terminal 120 initializes ranking information of the game match based on the multiple contestants. In some embodiments, in the game match, each contestant can choose which virtual image to use in the current game match. This virtual image does not change with a round change in the game match, but can be changed in different game matches. For example, the first user controls a first virtual image in the game match by using the first terminal 120.

The first terminal 120 and the second terminal 160 communicate directly or indirectly with the server 140 by using a wireless network or a wired network.

The server 140 includes at least one of one server, multiple servers, a cloud computing platform, or a virtualization center. The server 140 is configured to provide a background service for a game application that supports a virtual environment. In some embodiments, the server 140 undertakes primary computing work, and the first terminal 120 and the second terminal 160 undertake secondary computing work. Alternatively, the server 140 undertakes secondary computing work, and the first terminal 120 and the second terminal 160 undertake primary computing work. Alternatively, coordinated computing is performed among the server 140, the first terminal 120, and the second terminal 160 by using a distributed computing architecture.

The server may be an independent physical server, or a server cluster or a distributed system formed by multiple physical servers, or a cloud server that provides basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The second terminal 160 installs and runs a game application that supports a virtual environment. In some embodiments, the game application includes: any one of auto chess, a multi-player strategy round chess and card game, a virtual reality application, a three-dimensional map application, or a multi-player equipment survival game. In some embodiments, the second terminal 160 is a terminal used by a second user. When the second terminal 160 runs the game application, a user interface of the game application is displayed on a screen of the second terminal 160, and an opening request is sent to the server 140 based on an opening operation performed by the second user in the user interface. The server 140 returns, to the second terminal 160, multiple contestants (using an example in which the second user and the first user are in the same game match) that are matched with the game match, and the second terminal 160 initializes ranking information of the game match based on the multiple contestants. In some embodiments, the second user controls a second virtual image in the game match by using the second terminal 160.

In some embodiments, the first virtual image controlled by the first terminal 120 and the second virtual image controlled by the second terminal 160 are in the same game match, and the first virtual image and the second virtual image match each other in a current round, that is, a first round, to become interactive opponents. In the first round, the first user and the second user collocate their respective virtual object lineups in a preparation phase of the first round, and select which field objects to be selected in the first round. After the first round starts, the virtual object lineups of both parties are controlled by the system to start automatic confrontation until all field objects of one party are defeated, and the remaining surviving party wins the first round. In addition, a certain virtual health value of the virtual image controlled by the loser is deducted. Multiple rounds of confrontation between every two contestants is repeated, until a virtual image of only one contestant is still alive, and the winner and the loser can be separated in the game match.

In an example scenario, the first terminal 120 enters a preparation phase of a round of a game match, and an interactive opponent of this round is requested from the server 140 to be the second user. In this case, based on the method provided in this embodiment of the present disclosure, a prompt special effect for the interactive opponent is played on a preparation interface of this round.

Device types of the first terminal 120 and the second terminal 160 are the same or different, and the device type includes: at least one of a smartphone, a tablet computer, a smart sound box, a smart watch, a smart handheld console, a portable game device, an in-vehicle terminal, a laptop portable computer, or a desktop computer, and is not limited thereto. For example, both the first terminal 120 and the second terminal 160 are smartphones or other portable game devices. The following embodiments are described by using an example in which a terminal includes a smartphone.

A person skilled in the art can learn that a quantity of the foregoing terminals is more or less. For example, the foregoing terminal is only one, or the foregoing terminal is dozens or hundreds, or more. A quantity of terminals and a device type are not limited in the embodiments of the present disclosure.

FIG. 2 is a flowchart of a special effect display method according to an embodiment of the present disclosure. Referring to FIG. 2, this embodiment is performed by an electronic device. An example in which the electronic device is a terminal is used for description. The terminal may be provided as the first terminal 120 or the second terminal 160 in the foregoing implementation environment. This embodiment includes the following operations:

201. A terminal displays a preparation interface of a first round of a game match, multiple contestants in the game match being displayed in the preparation interface.

The first round is any round in the game match other than the initial round.

In some embodiments, the game match refers to any virtual match involving multiple contestants in a multiple-player strategy round chess and card game, and because it is a chess and card game, the virtual match may also be referred to as virtual chess, a virtual card game, a virtual chess game, or the like. This is not specifically limited in this embodiment of the present disclosure. A game match involves multiple contestants. A quantity of contestants allowed to join each game match is preconfigured by a technical person. For example, the quantity of contestants is 8, or the quantity of contestants is 10. This embodiment of the present disclosure sets no specific limitation on the quantity of contestants involved in the game match.

In some embodiments, each game match includes multiple rounds, and the round may be divided into an opponent round in which contestants confront with each other, and a non-opponent round not involving confrontation between contestants. For example, the non-opponent round may include rounds such as a jungle round and an auction round. The jungle round refers to a round in which each contestant confronts with a virtual wild monster, and the auction round refers to a round in which each contestant purchases some virtual trophies from a virtual store. A type of the non-opponent round is not specifically limited in this embodiment of the present disclosure.

In some embodiments, In the opponent round, the system performs matching for the multiple contestants in pairs, and two successfully matched contestants are mutually interactive opponents of a current opponent round. In this way, the multiple contestants can implement 1v1 confrontation in pairs. After the 1v1 confrontation ends, a certain virtual health value is deducted from a virtual image controlled by the loser, and an algorithm for deducting the virtual health value is preset on a system side, and is not specifically limited herein. In some embodiments, if a virtual health value of a virtual image controlled by a contestant decreases to 0 or is less than a preset threshold, the contestant is eliminated from a game match. If a virtual health value of a virtual image controlled by a contestant is greater than 0 or not less than a preset threshold, the contestant continues a current game match. The preset threshold may be a value preconfigured by a technical person.

In some embodiments, a preparation stage is configured before any round of a game match starts. A contestant may complete a series of preparation operations such as store card extraction, lineup improvement, stance adjustment, equipment provision, and information obtaining in the preparation stage. The method in this embodiment of the present disclosure is implemented in a preparation stage before an opponent round starts.

In some embodiments, for a first round in a game match, the first round is any round other than the initial round in the game match. At the end of a previous round performed before the first round, a preparation phase of the first round is entered, and a terminal switches from an interactive interface of the previous round to a preparation interface of the first round. In some embodiments, this preparation interface displays multiple contestants in the current game match. The contestant is a game account participating in the game match. The current game match will not add any new contestants, but will eliminate original contestants with the round change, until a virtual image controlled by only one contestant survives, and the winner and the loser are separated in the game match.

In some embodiments, for the foregoing preparation interface, when the multiple contestants are displayed, a ranking of each contestant at a current moment in the current game match is displayed in a ranking list. For example, the terminal performs ranking in descending order according to the virtual health values of the virtual images controlled by the contestants, or the terminal performs ranking in descending order according to confrontation scores obtained by each contestant in all previous rounds until the current moment, or the terminal arranges the ranking list according to another ranking algorithm. This is not specifically limited in this embodiment of the present disclosure.

202. The terminal determines an interactive opponent of the first round from the multiple contestants in response to the first round being an opponent round, the opponent round being an interactive round between the contestants.

In some embodiments, after entering the preparation stage of the first round, the terminal detects a round type of the first round. If the round type indicates that the first round is an opponent round, both confrontation parties in the first round are contestants in the game match, and do not involve a system-controlled non-player character (NPC) object or an artificial intelligence (AI) model-controlled NPC object. In response to the first round being an opponent round, the terminal sends an opponent matching request to the server, and the server allocates an interactive opponent to the terminal from the multiple contestants in response to the opponent matching request, and delivers an opponent identifier of the allocated interactive opponent to the terminal. An allocation algorithm of the interactive opponent is not specifically limited herein. The terminal receives the opponent identifier returned by the server based on the opponent matching request; and determines, according to the opponent identifier, the interactive opponent indicated by the opponent identifier from the multiple contestants. In some embodiments, the opponent identifier may include an account identifier of an interactive opponent, and the account identifier is configured for uniquely identifying a contestant.

In some other embodiments, after entering the preparation phase of the first round, the terminal detects the round type of the first round. If the round type indicates that the first round is a non-opponent round, the terminal does not need to display a prompt special effect for the interactive opponent by using the following operation 203. In this case, a round mark of the non-opponent round may be displayed in the preparation interface, and the round mark is configured for identifying a round type of the non-opponent round. For example, different round identifiers are configured for a jungle round and an auction round, so that the type of the non-opponent round of the first round can be fully reflected by using the round mark.

203. The terminal displays, in response to that the preparation interface does not contain an obstruction, a prompt special effect for the interactive opponent, the prompt special effect being configured for prompting a user to interact with the interactive opponent in the first round, and the obstruction referring to an interface element capable of shielding the prompt special effect.

In some embodiments, the prompt special effect is configured for reminding the user of the interactive opponent in the first round. The user mentioned herein refers to a player who has entered or is about to enter the first round, that is, the user controls the contestant to participate in the game match through the terminal. For example, a user 1 and a user 2 interact in the same first round. For a terminal 1 used by the user 1, prompt special effect information displayed by the terminal 1 is configured for reminding the user 1 that the interactive player in the first round is an opponent controlled by the user 2. For the terminal 2 used by the user 2, prompt special effect information displayed by the terminal 2 is configured for reminding the user 2 that the interactive player in the first round is an opponent controlled by the user 1.

In some embodiments, the special effect information is configured for differentially displaying interactive opponents. A display form of the special effect information includes at least one of the following: a dynamic special effect and a static special effect. The dynamic special effect is configured for differentially displaying the interactive opponent dynamically, and the static special effect is configured for differentially displaying the interactive opponent statically. For example, a display style that is different from that of another contestant is configured for displaying identification information of the interactive opponent. For a display style of the special effect information, refer to the following embodiment.

In some embodiments, the terminal detects whether the preparation interface includes an interface element obstruction that can shield a prompt special effect. In some embodiments, if the preparation interface does not include an obstruction, the terminal plays, on the preparation interface, the prompt special effect for the interactive opponent, so as to remind that the interactive opponent is matched in the first round, so that the user can directly enter, by performing a trigger operation on the prompt special effect, an observation interface of the interactive opponent, so as to facilitate observation of a virtual object lineup (such as a chess piece lineup) and a stance in a second round from a perspective of the interactive opponent.

In this way, on one hand, a prominent special effect for an interactive opponent is provided, making the interactive opponent more prominent among multiple contestants, preventing the user from forgetting or missing an important strategy prompt provided in the first round of the interactive opponent. On the other hand, this method further provides a shortcut entry to the observation interface. In a playback process of the prompt special effect, the user can enter the observation interface at any time by using the prompt special effect, thereby shortening an operation link for the user to enter the observation interface, simplifying an operation required for the user to enter the observation interface, and improving human-computer interaction efficiency.

Before the prompt special effect is displayed, the terminal detects in advance whether the preparation interface includes an obstruction, and the terminal plays the prompt special effect only when no obstruction is included. If the preparation interface does not contain an obstruction, the prompt special effect can be played. Checking the obstruction helps ensure that the prompt special effect is not to be shielded, so that the user can freely select when to enter the observation interface by using the prompt special effect, providing the user with a high degree of freedom of operation. In some embodiments, if the preparation interface includes an obstruction (for example, the user is opening a function pop-up window such as a virtual store or a virtual equipment bar to perform some other preparation operations), only when detecting that the function pop-up window is closed, the terminal determines that no obstruction is included. In this case, it is equivalent to providing delay play logic for the prompt special effect, avoiding that the prompt special effect is shielded by the function pop-up window, causing the user to miss an opportunity of obtaining a strategy prompt for the interactive opponent, thereby improving information obtaining efficiency of the user.

204. The terminal switches from the preparation interface to an observation interface of a second round in response to a trigger operation on the prompt special effect, the observation interface being configured for displaying an interaction behavior of the interactive opponent in the second round.

In some embodiments, the second round refers to any one or more rounds occurring in the game match before the first round. In some embodiments, the first round is an nth round in the game match, the second round is an m^{th} round in the game match, n is a positive integer, and m is a positive integer less than n. For example, the second round is a previous round of the first round. In some embodiments, the first round is the nₜₕ round in the game match. The second round includes any round from the m^{th} round to a p^{th} round in the game match. m is less than p, and p is a positive integer less than n.

For example, the second round is preset, for example, the second round is fixed as the previous round of the first round. For example, the second round is selected by the user. For example, the terminal obtains a round identifier of the second round in response to an operation indicating the second round. The terminal determines the second round according to the round identifier, requests an observation interface of the second round from the server, and the terminal displays the observation interface. In some embodiments, in the playback process of the prompt special effect, the user may perform a trigger operation on the prompt special effect at any time. When detecting the trigger operation of the user on the prompt special effect, the terminal switches from the preparation interface of the first round to the observation interface of the second round of the interactive opponent in response to the trigger operation on the prompt special effect. In some embodiments, the terminal displays, at an upper layer of the preparation interface, the observation interface of the second round of the interactive opponent, or the terminal device cancels display of the preparation interface, and displays the observation interface of the second round of the interactive opponent.

In some embodiments, an interaction behavior of the interactive opponent in the second round is displayed in the observation interface. For example, the observation interface is configured for displaying a game picture or a game video that is related to interaction with the interactive opponent in the second round. In some embodiments, content displayed in the observation interface is related to a perspective of the interactive opponent. The user observes the interaction behavior of the interactive opponent in the second round from the perspective of the interactive opponent in the observation interface.

In some embodiments, the interaction behavior includes but is not limited to at least one of the following: a virtual opponent lineup used by the interactive opponent in the second round, a virtual object stance arranged by the interactive opponent in the game gameboard in the second round, and an interactive prop used by the interactive opponent in the second round.

In some embodiments, the observation interface is configured for displaying a game picture of the interactive opponent on at least one time point of the second round. The game picture is pulled by the terminal from the server in response to the trigger operation, or obtained by the terminal from a terminal used by the opponent.

For example, the at least one time point refers to any time point in the second round, and a time interval between two adjacent time points may be the same or different. For example, the at least one time point includes a key time point at which a quantity of virtual objects in a game gameboard changes. By displaying a game picture corresponding to a key time point, the user can not only understand a gameboard layout of the interactive opponent, but also needs to consume only a relatively small picture transmission resource, which helps relieve data transmission pressure of the server.

In some embodiments, the observation interface is configured to display a video stream that is in the second round and that is in a confrontation process in the interactive opponent's observation angle. The video stream may be a live video stream or a historical video stream. The video stream is pulled by the terminal from the server in response to the trigger operation.

In some embodiments, the trigger operation on the prompt special effect includes but is not limited to: a click operation, a press operation, a touch operation, a long press operation, a double click operation, a multi-finger operation, a voice instruction, a gesture instruction, and the like. This is not specifically limited in this embodiment of the present disclosure. For example, the terminal responds to a click operation on the prompt special effect, and displays the observation interface of the interactive opponent.

In some embodiments, each round is performed by pairing multiple contestants in groups for confrontation, and therefore, confrontation in the second round of the interactive opponent at a current moment does not necessarily end. In some embodiments, if confrontation in the second round has not ended, the terminal directly enters the observation interface of the second round to observe the live video stream of the second round in the interactive opponent's observation angle (which is in the same view as the interactive opponent, but cannot control the chess piece and stance of the interactive opponent). If confrontation in the second round has ended, the terminal pulls the history video stream of the interactive opponent in the second round, and plays the history video stream locally.

The observation angle and the interactive opponent are in the same viewing angle. This only represents that the gameboard interface layout and the main operator viewed from the observation angle are the interactive opponent (not other opponents of the interactive opponent in the second round). However, due to different operation permissions, only a part of the interactive opponent's strategy layout can be seen from the observation angle. For example, the interactive opponent may view a field object that the interactive opponent is confronting in the confrontation area of the gameboard, and may also view a virtual object that the interactive opponent may select in the preparation area of the gameboard, and the user only enables a viewing permission to the confrontation area of the gameboard from the observation angle. That is, from the observation angle, only which field objects are selected by the interactive opponent in the second round can be viewed, and the user can only use the virtual object lineup in the second round as a reference for the first round, but the user cannot learn which candidate virtual objects are available to the interactive opponent. In this way, the antagonism, strategy, and fun of the game can be enhanced.

All the foregoing example technical solutions can be combined in different manners to form other embodiments of the present disclosure, and details are not described herein.

According to the method provided in this embodiment of the present disclosure, in a preparation phase of an opponent round, both parties involved in confrontation are contestants of a game match. First, it is detected whether the preparation interface includes an obstruction. Only in response to that there is no obstruction, the terminal plays a prompt special effect for the interactive opponent, so that a user can quickly enter, by using the prompt special effect, an observation interface in a completed or ongoing round of the interactive opponent. On one hand, this prompt special effect is used for emphasizing the matched interactive opponent. On the other hand, by using detection logic of the obstruction, the user can avoid missing the prompt special effect because the prompt special effect is shielded, and avoid forgetting or missing this very important strategy prompt of the interactive opponent. In a playback process of the prompt special effect, the user can enter the observation interface at any time by using the prompt special effect, thereby shortening an operation link for the user to enter the observation interface, and improving human-computer interaction efficiency.

In the foregoing embodiment, an interaction manner and a display process for a prompt special effect of an interactive opponent are briefly described. However, in this embodiment of the present disclosure, an example in which a multi-player strategy round chess and card game is auto chess is configured for describing a process of displaying a prompt special effect of an interactive opponent in auto chess, which is described in the following.

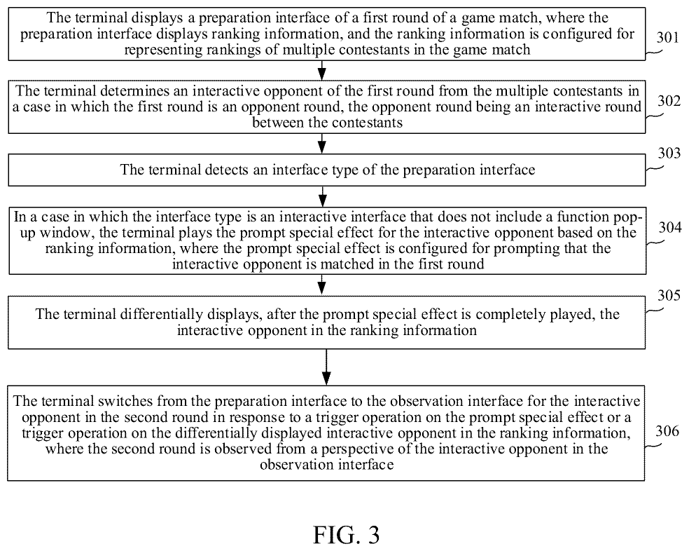

FIG. 3 is a flowchart of a special effect display method according to an embodiment of the present disclosure. Referring to FIG. 3, this embodiment is performed by an electronic device. An example in which the electronic device is a terminal is used for description. The terminal may be provided as the first terminal 120 or the second terminal 160 in the foregoing implementation environment. This embodiment may include the following several operations.

301. The terminal displays a preparation interface of a first round of a game match, where the preparation interface displays ranking information, and the ranking information represents rankings of multiple contestants in the game match.

In some embodiments, there is a preparation stage for each round of any game match of auto chess that is configured before it starts. After the end of the second round, the user automatically enters the preparation phase of the first round, and the terminal switches from the interactive interface of the previous round of the first round to the preparation interface of the first round. For auto chess, at least the gameboard of the first round and all contestants in the game match are displayed in the preparation interface. If the first round is an opponent round of confrontation between contestants, the user's interactive opponent in the first round will be matched from all contestants in the game match. A matching algorithm is preset on the server side, and is not specifically limited herein.

In some embodiments, the ranking information is configured for displaying rankings of multiple contestants in the game match. In some embodiments, the ranking information may be displayed in a form of a ranking list, for example, the ranking information is a list, and each row in the list is configured for displaying one contestant. For example, contestants in adjacent locations in the list have similar rankings or the same ranking in the game match. For example, display locations of the multiple contestants in the list are randomly determined.

In this embodiment of the present disclosure, an example in which all contestants of the game match are displayed in a form of a ranking list in the preparation interface is used for description. In the preparation interface, the terminal generates, according to a preset ranking rule, ranking information of all the contestants of the game match. The ranking information includes at least one contestant in the game match.

In some embodiments, the ranking information will be refreshed in real time with the game match. For example, when a ranking of any contestant changes, the ranking information displays a new ranking of each contestant after the ranking changes. For another example, after any contestant is eliminated, the ranking information may prompt the eliminated contestant (for example, whether the contestant is eliminated is prompted by changing transparency and a gray level). For another example, an identifier of a text or an icon is added to a nickname of an account to prompt whether the contestant is eliminated. This is not specifically limited in this embodiment of the present disclosure.

In some embodiments, the foregoing preset ranking rule includes but is not limited to at least one of the following: ranking in descending order of virtual health values of virtual images mastered by respective contestants, ranking in descending order of confrontation points achieved by the respective contestants in all previous rounds up to the current moment, and arranging a ranking list according to other ranking algorithms. The ranking rule is set according to an actual requirement, which is not specifically limited in this embodiment of the present disclosure.

In some embodiments, when the ranking information is displayed on the preparation interface, the terminal displays all contestants of the game match according to the rankings. In some embodiments, for each contestant displayed in the ranking information, the ranking information displays an account nickname of a game account corresponding to the contestant. In some embodiments, the ranking information further displays an identifier avatar of a virtual image controlled by the contestant as an account avatar. In some embodiments, the ranking information further displays the remaining virtual health value of the virtual image controlled by the contestant. When the virtual health value is displayed, the virtual hit point may be displayed in a manner of a blood volume progress bar or a value, or the account avatar is used as a blood volume progress bar to simplify a layout of the ranking information. A layout manner of the ranking information is not specifically limited in this embodiment of the present disclosure.

In some embodiments, the opponent a player faces each round is not predetermined but is randomly assigned by the system/server from a certain pool of players (e.g., based on the ranking information). This randomness introduces uncertainty but also increases the game's playability. For example, the potential opponents for the next round can be marked on the leaderboard (e.g., a board that presents the ranking information) on the right side of the interface using special icons. The system/server can randomly assign one of these players as the opponent for the next round.

In some embodiments, the ranking information may be displayed at any location in the preparation interface. For example, the ranking information is displayed on the left, right, top, and bottom of the preparation interface, and a display location of the ranking information is not specifically limited herein. In an example, a ranking control is provided in the preparation interface. If the ranking control is in an expanded state, the terminal displays the ranking information in the preparation interface in an expanded state. If the ranking control is in a collapsed state, the terminal hides or collapses the ranking information and does not display the ranking information. For example, a status of the ranking control is determined by the user. For example, the terminal switches the ranking control from an expanded state to a collapsed state in response to a status switching operation on the ranking control. In this manner, the ranking information can be prevented from shielding the gameboard, which helps optimize a resource layout manner of the preparation interface.

302. The terminal determines an interactive opponent of the first round from the multiple contestants in response to the first round being an opponent round, the opponent round being an interactive round between the contestants.

In some embodiments, after entering the preparation stage of the first round, the terminal detects a round type of the first round. The terminal determines, based on the round type, whether the first round is an opponent round or a non-opponent round, where the opponent round refers to a round in which the contestants confront with each other in pairs, and the non-opponent round refers to a round in which the contestants confront with an NPC object controlled by the system or AI. For example, the non-opponent round includes at least one of the following: a jungle round and a round that does not involve confrontation between two parties (e.g. an auction round).

In some embodiments, the foregoing round type is implemented as a type ID of the first round, and the type ID may indicate a round confrontation attribute. For example, the type ID may be player VS player (PVP) or player VS environment (PVE). For example, if the terminal detects that the value of the type ID of the first round is PVP, it is determined that the first round is an opponent round. If the terminal detects that the value of the type ID of the first round is PVE, the terminal determines that the first round is a non-opponent round.

In some embodiments, the foregoing round type is implemented as a round ID of the first round, and the round ID is not configured for indicating a round confrontation attribute, and is only configured for indicating a round type. For example, a configuration manner of the round ID is: opponent round ID_001, jungle round ID_002, and auction round ID_003.

In an example, an ID list of an opponent round is preconfigured on the terminal side. If only {ID_001} is stored in the ID list of the opponent round, the terminal queries the round ID of the first round. If the round ID of the first round can hit any element in the pre-stored ID list of the opponent round, the terminal determines that the first round is an opponent round; otherwise, the terminal determines that the first round is a non-opponent round.

In another example, an ID list of a non-opponent round is preconfigured on the terminal side. If {ID_002, ID_003} is stored in the ID list of the non-opponent round, the terminal queries the round ID of the first round. If the round ID of the first round does not hit all elements in the pre-stored ID list of the non-opponent round, the terminal determines that the first round is an opponent round. Otherwise, the terminal determines that the first round is a non-opponent round.

In some embodiments, in the game service logic, a part of rounds configured with fixed sequences in the game match are opponent rounds, and the other part of rounds are non-opponent rounds. For example, the third round of each game match is fixed as a jungle round, the sixth round is fixed as an auction round, and the remaining rounds are all opponent rounds. In this case, the terminal detects only a round sequence of the first round. If the round sequence meets a preset fixed sequence of the opponent round in the game service logic, the terminal determines the first round as an opponent round. Otherwise, the terminal determines the first round as a non-opponent round. Alternatively, if the round sequence meets a preset fixed sequence of the non-opponent round in the game service logic, the terminal determines the first round as a non-opponent round. Otherwise, the terminal determines the first round as an opponent round. In this embodiment of the present disclosure, a fixed sequence that is preset in the game service logic and that indicates that the first round is an opponent round or a non-opponent round is not specifically limited.

In some embodiments, in response to the first round being an opponent round, the terminal sends an opponent match request to the server. In response to the opponent matching request, the server allocates an interactive opponent to the terminal from the multiple contestants, and delivers an opponent identifier of the allocated interactive opponent to the terminal. An allocation algorithm of the interactive opponent is not specifically limited herein. The terminal receives an opponent identifier returned by the server based on the opponent matching request, and the terminal determines, according to the opponent identifier, an interactive opponent indicated by the opponent identifier from the multiple contestants. In some embodiments, the opponent identifier may include an account identifier of an interactive opponent, and the account identifier is configured for uniquely identifying a contestant.

In some other embodiments, in response to that the first round is a non-opponent round, the terminal does not need to display a prompt special effect for the interactive opponent. In some embodiments, in this case, the terminal displays the round identifier of the non-opponent round in the preparation interface, and the round identifier is configured for identifying the round type of the non-opponent round. For example, different round identifiers are configured for the jungle round and the auction round, so that a type of a non-opponent round of the first round can be fully reflected by using the round identifier.

303. The terminal detects an interface type of the preparation interface.

In some embodiments, because the user may open some function pop-up windows in the preparation interface, or expand some interactive controls, the preparation interface contains an obstruction that can shield a prompt special effect. Therefore, before displaying the prompt special effect, the terminal needs to detect the interface type of the preparation interface at the current moment. The interface type represents a display location on the preparation interface.

In some embodiments, The interface type includes: an interactive interface that includes a function pop-up window and an interactive interface that does not include a function pop-up window. The interactive interface that includes a function pop-up window is configured for indicating that the function pop-up window is displayed on the preparation interface, and the interactive interface that does not include a function pop-up window is configured for indicating that the function pop-up window is not displayed on the preparation interface. For simplicity, an interactive interface that does not include a function pop-up window may be referred to as a head up display (HUD) interface. The HUD interface refers to an interactive interface that does not include any function pop-up window by default in a game match. For example, a function pop-up window is used by a user to complete a function interaction in a game match. The function pop-up window includes but is not limited to: a virtual store pop-up window, a talent configuration pop-up window, a virtual equipment bar pop-up window, etc.

In some embodiments, the terminal queries the interface type of the preparation interface at the current moment. If the interface type is an HUD interface, the terminal performs operation 304 to directly play the prompt special effect for the matched interactive opponent in operation 302. In this manner, it helps ensure that the prompt special effect is not shielded by the function pop-up window, so as to avoid that the prompt special effect is ignored due to shielding, and improve information obtaining efficiency of the user.

In some other embodiments, the terminal queries the interface type of the preparation interface at the current moment. If the interface type is not an HUD interface, a function pop-up window has been opened in the current preparation interface. In this case, the terminal always delays playback of the prompt special effect. That is, in response to that the interface type is an interactive interface that includes a function pop-up window, after detecting that the function pop-up window is closed, the terminal displays the prompt special effect on the preparation interface. In other words, if the preparation interface includes a function pop-up window, after the function pop-up window is closed, the interface type changes to the HUD interface, and then operation 304 is performed to play the prompt special effect, to implement a delayed playback strategy for a prompt special effect. In some embodiments, the terminal registers a callback function or a hook function for a pop-up window close operation, so as to detect, in real time by using the callback function or the hook function, whether a pop-up window close operation occurs, so as to improve real-time performance of playing the prompt special effect. The callback function (or the hook function) is configured to: when a pop-up window close operation is received, instruct the terminal to perform a process or a thread that plays a prompt special effect.

In some other embodiments, if the interface type is not an HUD interface, that is, in response to that the interface type is an interactive interface that includes a function pop-up window, the terminal determines whether a function pop-up window and a display area of a prompt special effect overlaps, and therefore decides to play the prompt special effect instantly or in a delayed manner. Because duration of the preparation phase is limited, in this method, a prompt special effect is not always played in a delayed manner when a function pop-up window is detected, so as to avoid a case in which when the prompt special effect is played in a delayed manner, the user misses an occasion of adjusting a virtual object lineup of the user according to a virtual object lineup of an interactive opponent. In addition, flexibility of the method for displaying the prompt special effect is improved, which helps further improve information obtaining efficiency of the user.

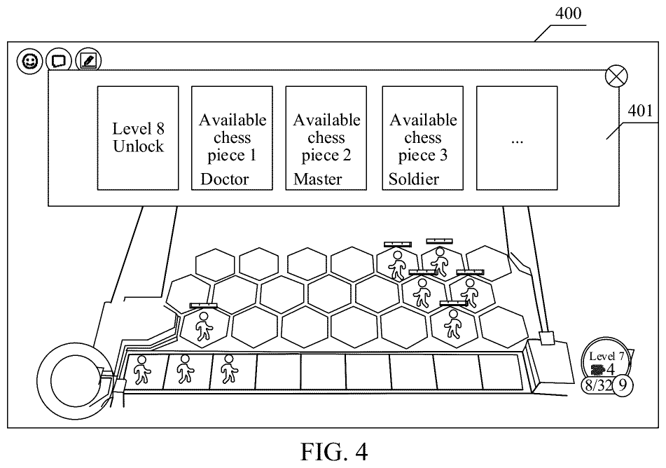

FIG. 4 is a schematic diagram of a preparation interface that includes a function pop-up window according to an embodiment of the present disclosure. As shown in FIG. 4, the preparation interface 400 includes a function pop-up window 401. Using the function pop-up window 401 being a virtual store pop-up window as an example, the user may purchase, in the virtual store pop-up window, a virtual object required by the user, or randomly select a new virtual object in a card extraction manner, so as to implement storage pool expansion for a candidate virtual object. In some embodiments, because the preparation interface 400 includes the function pop-up window 401, the terminal always performs delayed playback for the prompt special effect, or the terminal further determines whether a display area of the function pop-up window and a display area of the prompt special effect overlap, so as to accurately determine whether to perform delayed playback for the prompt special effect.

For example, if the interface type is not an HUD interface, that is, in response to that the interface type is an interactive interface that includes a function pop-up window, because the terminal has already obtained an interactive opponent in the first round by using operation 302, each contestant displayed on the ranking information has a different ranking, and contestants with different rankings have different locations in the preparation interface, the terminal determines the display area of the prompt special effect based on the location of the interactive opponent in the ranking information. For example, a target range of the location of the interactive opponent in the ranking information is determined as the display area of the prompt special effect. In some embodiments, the target range is determined according to a moving track of the prompt special effect, or the target range is a fixed-size bounding box that centers on the location of the interactive opponent in the ranking information. A manner of determining the target range is not specifically limited in this embodiment of the present disclosure.

In some embodiments, the terminal determines whether there is an overlapping area between the function pop-up window currently included in the preparation interface and the display area of the prompt special effect. In some embodiments, if there is no overlapping area between the function pop-up window and the display area of the prompt special effect, that is, in response to that the function pop-up window does not shield the display area, the terminal directly displays the prompt special effect on the preparation interface. In the foregoing process, even if the interface type of the preparation interface is not an HUD interface, the terminal does not always delay playing of the prompt special effect, but further determines whether a function pop-up window opened in the preparation interface causes an obstruction to an expected display area of the prompt special effect. If the function pop-up window and the expected display area of the prompt special effect do not overlap with each other, the function pop-up window is directly displayed in the preparation interface and the prompt special effect is played. In this manner, a quantity of information carried in the preparation interface is increased, and it is ensured that the prompt special effect and the function pop-up window do not interfere with each other, thereby improving human-computer interaction efficiency of the user.

In some other embodiments, when there is an overlapping area between the function pop-up window and the display area of the prompt special effect, delayed playback may be performed on the prompt special effect. In some embodiments, when the terminal waits for the function pop-up window to be closed or the function pop-up window does not overlap with the display area of the prompt special effect, the terminal plays the prompt special effect in the preparation interface.

In some embodiments, in response to that an overlapping area exists between the function pop-up window and the display area of the prompt special effect, it may be further detected whether the overlapping area includes an interactive control in the function pop-up window. For example, if the overlapping area does not include the interactive control in the function pop-up window, after placing the prompt special effect at the top layer, the terminal displays the prompt special effect. If the overlapping area includes the interactive control in the function pop-up window, the terminal performs delayed playback for the prompt special effect. For example, when the terminal detects that the overlapping area does not include an interactive control, or detects that the function pop-up window does not overlap the display area of the prompt special effect, or detects that the function pop-up window is closed, the terminal plays the prompt special effect on the preparation interface.

In this manner, even if there is an overlapping area between the function pop-up window and the display area of the prompt special effect, but the overlapping area does not include an interactive control that supports interaction, displaying the prompt special effect on the overlapping area does not affect interaction logic of the function pop-up window based on the interactive control. Therefore, the terminal sets the prompt special effect to the top for display, so as to ensure that the interaction logic based on the function pop-up window is not affected, and ensure that the prompt special effect for the interactive opponent is displayed in time as far as possible, thereby further improving interface resource utilization and human-computer interaction efficiency.

In some other embodiments, in response to that the overlapping area includes an interactive control in the function pop-up window, if the display area is determined based on a moving track of the prompt special effect, the terminal adjusts the moving track of the prompt special effect, and then determines an adjusted display area based on an adjusted moving track. In some embodiments, if the adjusted display area does not include the interactive control in the function pop-up window, or the adjusted display area does not overlap the function pop-up window, the terminal displays the prompt special effect for the interactive opponent according to the adjusted moving track. In this way, a delay in playing the prompt special effect can be avoided as much as possible, which ensures that the prompt special effect played in time does not adversely affect the interaction function in the function pop-up window.

304. In response to that the interface type is an interactive interface that does not include a function pop-up window, the terminal plays the prompt special effect for the interactive opponent based on the ranking information, where the prompt special effect is configured for prompting that the interactive opponent is matched in the first round.

In some embodiments, in response to that the interface type of the preparation interface is an HUD interface, that is, the interface type is an interaction interface that does not include a function pop-up window, or in response to that the interface type is an interaction interface that includes a function pop-up window but the function pop-up window does not overlap with the display area of the prompt special effect, or in response to that the interface type is an interaction interface that includes a function pop-up window and the overlapping area between the function pop-up window and the display area of the prompt special effect does not include an interactive control in the function pop-up window, the terminal plays the prompt special effect for the interactive opponent based on the foregoing operation 304.

In some embodiments, when the foregoing prompt special effect is played, the terminal implements playing of the prompt special effect based on the ranking information. For example, the terminal determines, according to the location of the interactive opponent in the ranking information, a moving track of a prompt special effect that uses the foregoing location as an end point, and the terminal displays a movement process in which the prompt special effect is finally moved to the foregoing location along the moving track. A start point of the moving track is not specifically limited herein. For example, the start point of the track is a point (for example, a midpoint of a sideline) that is in the preparation interface and that is of the sideline closest to the end point of the moving track, or any intersection point of two intersection points between a horizontal line that passes through the foregoing location and the sideline of the preparation interface, or a center point of the preparation interface, or any start point randomly generated according to a track function. This is not specifically limited in this embodiment of the present disclosure.

In some embodiments, in the foregoing, the location of the interactive opponent in the ranking information is the end point of the moving track.

In some embodiments, the prompt special effect includes dynamic and static special effects. A display size of the dynamic special effect in the playback process gradually shrinks, and the static special effect is configured for differentially displaying an interactive opponent in the ranking information when playing of the dynamic special effect is completed. In some embodiments, the terminal displays a dynamic process in which the size of the dynamic special effect gradually shrinks in the playback process. At the end of playing, a static special effect included in the prompt special effect starts to be displayed, and the terminal displays the static special effect, so as to implement a display effect of the interactive opponent that is differentially displayed in the ranking information, so as to create a visual effect that the prompt special effect gradually flies towards the interactive opponent and converges to an account avatar of the interactive opponent. As a result, the playback process of the overall prompt special effect is more integrated with the account avatar, so that the display effect of the prompt special effect is optimized.

In some embodiments, an implementation of the prompt special effect for the interactive opponent includes but is not limited to: a spine special effect, a particle special effect, a dynamic effect, an animation, a flash, a dynamic sticker, a magic expression, etc. An implementation of the prompt special effect is not specifically limited in this embodiment of the present disclosure. In some embodiments, the prompt special effect may be locally generated on the terminal side, or may be generated on the server side and delivered to the terminal for playback. This embodiment of the present disclosure sets no specific limitation on a generation end device of the prompt special effect.

In some embodiments, that the terminal side locally generates the foregoing prompt special effect is used as an example. The terminal may obtain, based on the interactive opponent determined in operation 302, a virtual image controlled by the interactive opponent in the game match. The terminal generates the prompt special effect based on the virtual image of the interactive opponent in the game match. For example, the terminal generates a prompt special effect that includes the virtual object according to the image model of the virtual image controlled by the interactive opponent and the skin and the pendant that are worn by the interactive opponent for the virtual image, so as to conveniently emphasize, by using the prompt special effect, the interactive opponent matched in the first round, thereby improving information obtaining efficiency of the user.

In some embodiments, the terminal generates the prompt special effect based on a field object configured by the interactive opponent in the second round. The field object refers to a virtual object that was used by the interactive opponent in the second round. In some embodiments, the terminal requests, from the server, a virtual object lineup configured by the interactive opponent in the second round. For example, the virtual object lineup is provided as a field object ID list selected by the interactive opponent in the second round. The terminal generates the prompt special effect based on the field object ID list. For example, the terminal displays an account avatar of the interactive opponent, and displays, next to the account avatar, a chess piece name of each field object corresponding to the field object ID list. In this way, the user can clearly see the virtual object lineup of the interactive opponent in the second round by using the prompt special effect. If there is an observation requirement of further viewing the stance of each virtual object in the virtual object lineup, the user may trigger, by performing deep interaction with the interactive opponent displayed in the prompt special effect or the ranking information, to view stance details on the observation interface. In this way, information obtaining efficiency of the virtual object lineup can be prompted, thereby improving human-computer interaction efficiency.

In some embodiments, the terminal may further generate the prompt special effect based on the ranking of the interactive opponent in the ranking information and an account attribute of the interactive opponent. For example, the terminal reads a ranking of the interactive opponent at a current moment from the ranking information, obtains the account attribute of the interactive opponent (that is, a game account), for example, the account attribute includes an account nickname and an account avatar, and generates the prompt special effect based on the ranking, the account nickname, and the account avatar. In this manner, the user can quickly learn, by using the prompt special effect, the ranking, the nickname, and the avatar of the interactive opponent matched in the current interactive round, and can also emphasize the interactive opponent, so as to prompt the user to observe the virtual object lineup effect of the interactive opponent in a completed or ongoing round.

In an example embodiment, the terminal generates the prompt special effect based on a combination of the foregoing several manners. For example, the terminal generates, according to the ranking, the account nickname, and the controlled virtual image of the interactive opponent, a dynamic effect that includes a virtual object, and displays the ranking and the account nickname of the interactive opponent on the top or the bottom of the dynamic effect. If the user clicks this prompt special effect, the terminal displays the observation interface of the interactive opponent. If the user long presses the prompt special effect, the user can also view the virtual object lineup sent by the interactive opponent in the second round. That is, the user long presses the prompt special effect to view the field object ID list selected by the interactive opponent in the second round. In some embodiments, in the playback process of the prompt special effect, the terminal collapses the field object ID list by default, so as to avoid excessive occlusion by the field object ID list on the preparation interface. In this way, the prompt special effect itself contains rich interactive information, and information obtaining efficiency and man-computer interaction efficiency of the user can be improved.

Only example descriptions of trigger operations of viewing the virtual object lineup and entering the observation interface are provided herein. A technical person may define trigger operations of the two functions according to service requirements, for example, clicking “trigger” to view the virtual object lineup, and long pressing “trigger” to enter the observation interface; and for another example, clicking “trigger” to enter the observation interface, double-clicking “trigger” to view the virtual object lineup, and the like. This is not specifically limited in this embodiment of the present disclosure.

305. The terminal differentially displays, after the prompt special effect is completely played, the interactive opponent in the ranking information.

In some embodiments, after the prompt special effect is completely played, the terminal differentially displays the interactive opponent in the first round in the ranking information. For example, the display style of the interactive opponent is highlighted for differentiation, or is differentiated using transparency, differentiated using a background color, or differentiated using edge lighting. For another example, a confrontation mark is added to a side of the account avatar of the interactive opponent, so as to represent that a contestant carrying the confrontation mark is an interactive opponent of the first round. The playback duration of the prompt special effect may be preset by a technical person, and the playback duration is a value greater than 0. For example, the playback duration is 2 seconds, 3 seconds, 5 seconds, or the like. This is not specifically limited in this embodiment of the present disclosure.

By differentially displaying the interactive opponent, the interactive opponent is more prominent in the ranking information, so that the user can quickly determine the interactive opponent from the ranking information.

This embodiment of the present disclosure is merely described by using an example in which after the prompt special effect is completely played, the interactive opponent is differentially displayed. In some embodiments, there is no execution time sequence between the play operation of the prompt special effect and the operation of differentially displaying the interactive opponent in the ranking information. For example, the terminal first displays the interactive opponent in the ranking information, and then plays the prompt special effect for the interactive opponent. For another example, the terminal simultaneously differentially displays the interactive opponent in the ranking information, and plays the prompt special effect for the interactive opponent.

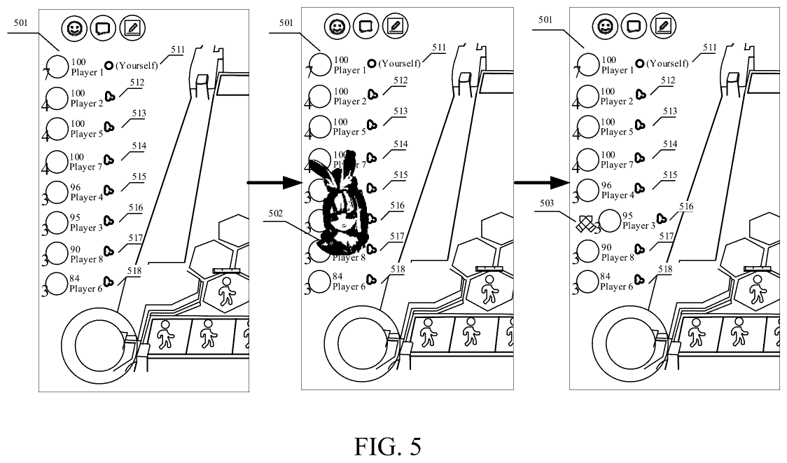

FIG. 5 is a playback flowchart of a prompt special effect according to an embodiment of the present disclosure. It is assumed that the second round refers to a previous round of the first round. As shown in FIG. 5, after the second round of confrontation of the contestant (that is, a contestant that uses the terminal to participate in a game match) of the terminal ends, an interaction result of the second round is settled, and the opponent and the gameboard of the second round displayed in the interactive interface are cleared. The terminal updates the ranking information according to the interaction result of the second round, and transfers the ranking information from the interactive interface of the second round to the preparation interface of the first round. Refer to the ranking area 501 in the preparation interface. The ranking area 501 displays the latest rankings of 8 contestants 511 to 518 after the second round is settled. In an example in which the terminal corresponds to the contestant 511 currently ranked first, after entering the preparation stage of the first round, the terminal requests the server to match the interactive opponent of the current round. If the contestant 516 whose target ranking is 6^{th} is matched as the interactive opponent, 1v1 confrontation is performed between the contestant 511 and the contestant 516 in the first round. In the preparation interface, the terminal plays a prompt special effect 502 generated by a virtual image controlled by the contestant 516, and the prompt special effect 502 has a relatively prominent visual prompt effect. In an example, when the prompt special effect 502 appears, the size thereof gradually shrinks, and converges to the contestant 516 in the ranking area 501 after the playback duration is reached. After the prompt special effect 502 is completely played, the terminal differentially displays the contestant 516 in the ranking area 501. For example, the terminal adds a confrontation mark 503 to the left of the account avatar of the contestant 516, so as to prompt, by using the confrontation mark 503, that the contestant 516 is the interactive opponent of the first round.

In the foregoing operations 304 and 305, a possible implementation of displaying the prompt special effect for the interactive opponent in the case in which the preparation interface does not include an obstruction is provided. The obstruction is an interface element that can shield the prompt special effect. The terminal plays the prompt special effect only in response to that there is no obstruction, which can ensure that the user has enough attention to the prompt special effect, so as to prevent the user from missing the prompt special effect, ensure that the user can adjust the virtual object lineup and the stance in the first round in a timely manner, and improve game strategy and interest.

306. The terminal switches from the preparation interface to the observation interface for the interactive opponent in the second round in response to a trigger operation on the prompt special effect or a trigger operation on the differentially displayed interactive opponent in the ranking information, where the second round is observed from a perspective of the interactive opponent in the observation interface.

In some embodiments, the terminal switches from the preparation interface to the observation interface in response to an operation of triggering the differentially displayed the interactive opponent in the ranking information. A meaning of “trigger operation on the differentially displayed interactive opponent in the ranking information” is the same as a meaning of “operation of triggering the differentially displayed interactive opponent in the ranking information”. The operation of triggering the differentially displayed interactive opponent in the ranking information includes but is not limited to at least one of the following: a click operation, a slide operation, a key operation, a long press operation or the like for the interactive opponent displayed in the area. The operation of triggering the differentially displayed interactive opponent in the ranking information is configured for switching the preparation interface to the observation interface.

In some embodiments, the user may perform a trigger operation on the prompt special effect at any time in the playback process of the prompt special effect. When detecting the trigger operation of the user on the prompt special effect, the terminal switches from the preparation interface of the first round to the observation interface of the second round of the interactive opponent in response to the trigger operation on the prompt special effect. In some embodiments, after the prompt special effect is completely played, if the user further wants to enter the observation interface, because the interactive opponent is displayed differentially in the ranking information in operation 305, the user can intuitively find the current interactive opponent when viewing the ranking information, and perform a trigger operation on the interactive opponent displayed differentially. When detecting that the user performs the trigger operation on the interactive opponent differentially displayed, the terminal switches from the preparation interface of the first round to the observation interface of the second round of the interactive opponent in response to the trigger operation on the interactive opponent differentially displayed. Multiple manners are configured for supporting access to the observation interface, so that the user can find a shortcut entry to the observation interface in the preparation interface during the playback process of the prompt special effect or after playback of the prompt special effect, thereby greatly improving an operation link for entering the observation interface, and improving human-computer interaction efficiency.

In some embodiments, after entering the observation interface, the terminal displays, in the observation interface, a video stream of the confrontation process in the second round in the observation angle of the interactive opponent. The video stream may be a live video stream or a historical video stream, and the video stream is pulled by the terminal from the server in response to the trigger operation.

In some embodiments, the trigger operation on the prompt special effect and the trigger operation on the interactive opponent differentially displayed may be the same or different. The foregoing trigger operation includes but is not limited to: a click operation, a press operation, a touch operation, a long press operation, a double click operation, a multi-finger operation, a voice instruction, a gesture instruction, and the like. This is not specifically limited in this embodiment of the present disclosure.

In some embodiments, each round is performed by pairing multiple contestants in groups for confrontation, and therefore, confrontation in the second round of the interactive opponent at a current moment does not necessarily end. if confrontation in the second round has not ended, the terminal directly enters the observation interface of the second round to observe the live video stream of the second round in the interactive opponent's observation angle (which is in the same view as the interactive opponent, but cannot control the chess piece and stance of the interactive opponent). If confrontation in the second round has ended, the terminal may pull the history video stream of the interactive opponent in the second round, and play the history video stream locally.

Although the observation angle and the interactive opponent are in the same viewing angle, this only represents that the gameboard interface layout and the main operator viewed from the observation angle are the interactive opponent (not other opponents of the interactive opponent in the second round). However, due to different operation permissions, for example, only a part of the interactive opponent's strategy layout can be seen from the observation angle. For example, the interactive opponent may view a field object that the interactive opponent is confronting in the confrontation area of the gameboard, and may also view a virtual object that the interactive opponent may select in the preparation area of the gameboard, and the user only enables a viewing permission to the confrontation area of the gameboard from the observation angle. That is, from the observation angle, only which field objects are selected by the interactive opponent in the second round can be viewed by the user, and the user can only use the virtual object lineup in the second round as a reference for the first round, but the user cannot learn which candidate virtual objects are available to the interactive opponent. In this way, the antagonism, strategy, and fun of the game can be enhanced.

In some other embodiments, the terminal jumps from the preparation interface to the foregoing observation interface in response to a trigger operation on the prompt special effect, or a trigger operation on the differentially displayed interactive opponent in the ranking information, or provides an observation sub-interface in the preparation interface in a form of a split screen, a multi-screen, a small window, a sub-window, a floating window, or the like. The video stream of the interactive opponent in the second round is played through the observation sub-interface. This makes it convenient for the user to observe the virtual object lineup and stance of the interactive opponent through the observation sub-interface, adjust which virtual objects to be sent out by the user as field objects through the preparation interface, and adjust the stance of the decided field object in the confrontation area in the gameboard. This manner helps avoid frequent switching by the user between the observation interface and the preparation interface, and greatly improves human-computer interaction efficiency. All the foregoing example technical solutions can be combined in different manners to form other embodiments of the present disclosure, and details are not described herein.

According to the method provided in this embodiment of the present disclosure, because both involved confrontation parties are game match contestants, in the preparation phase of the opponent round, the terminal first detects whether the preparation interface includes an obstruction. Only in response to that there is no obstruction, the terminal plays a prompt special effect for the interactive opponent, so that a user can quickly enter, by using the prompt special effect, an observation interface in a completed or ongoing round of the interactive opponent. On one hand, this prompt special effect is used for emphasizing the matched interactive opponent. On the other hand, by using detection logic of the obstruction, the user can avoid missing the prompt special effect because the prompt special effect is shielded, and avoid forgetting or missing this very important strategy prompt of the interactive opponent. In a playback process of the prompt special effect, the user can enter the observation interface at any time by using the prompt special effect, thereby shortening an operation link for the user to enter the observation interface, and improving human-computer interaction efficiency.

In the foregoing embodiment, the manner of generating the prompt special effect and displaying the prompt special effect is described in detail. For auto chess, by optimizing the display rule of the interactive opponent matched in the opponent round, the display mode of the opponent can be strengthened, and an exclusive prompt special effect (such as a dynamic expression, a particle special effect, and an animation) of the interactive opponent in the current round is given. When it is detected that a function pop-up window is included, the prompt special effect is directly delayed for playback, or when it is detected that an interaction function of the function pop-up window is not affected, the prompt special effect is played. On one hand, it can be avoided that a conflict of the prompt special effect is caused, and the prompt special effect cannot be played normally due to pop-up of the function pop-up window. On the other hand, even if the user ignores the prompt special effect because the prompt special effect is normally played but is shielded by the function pop-up window, which can greatly ensure that the user pays attention to the prompt special effect, thereby improving information obtaining efficiency of the user. Further, in the playback process of the prompt special effect, the user may enter an observation interface of a completed or ongoing round of the interactive opponent by using the prompt special effect. After the prompt special effect is completely played, the user may enter the observation interface by using the ranking area, so that the user can fully observe the virtual object lineup and the stance of the interactive opponent on the observation interface, and adjust its own virtual object lineup and stance accordingly, so as to achieve an effect of restraining the interactive opponent, improve game strategy and fun, and improve game experience of the user.

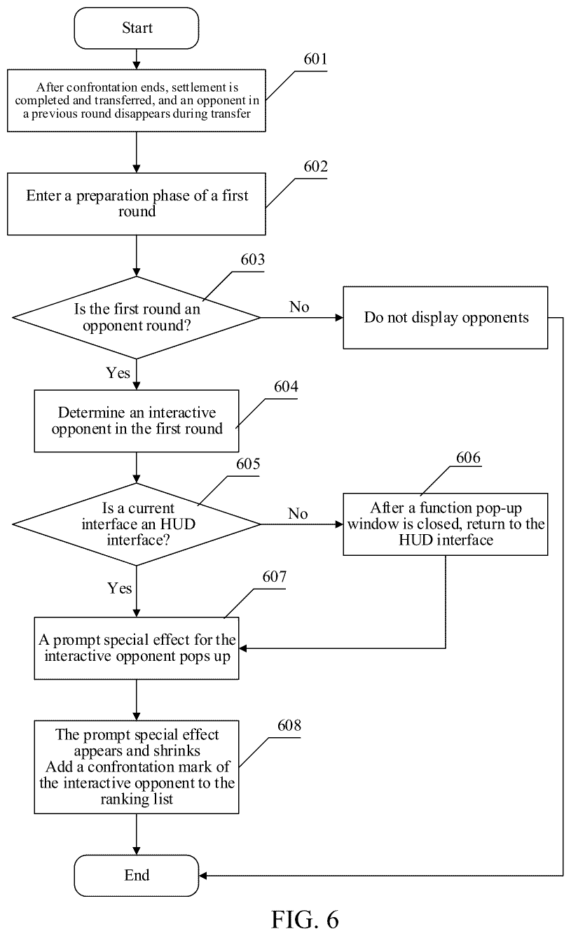

In this embodiment of the present disclosure, auto chess is used as an example to provide a specific possible implementation for the display process of the prompt special effect. FIG. 6 is a schematic diagram of a prompt special effect display process according to an embodiment of the present disclosure. As shown in FIG. 6, an execution body of the display method is an electronic device, and the electronic device being a terminal is used as an example for description. In this embodiment, an example in which the second round is a previous round of the first round is used for description.

Operation 601: After the second round ends, settlement is completed and transferred, and the opponent in the second round disappears during transfer.

That is, after the second round ends, the contestant A corresponding to the terminal obtains the settlement result of the second round. The terminal rewards the winner and punishes the loser based on the settlement result. For example, the winner is rewarded with a ranking increase or other additional spoils. For example, the loser is punished by a virtual health value (such as a hit point) of a virtual image controlled by the loser, and the ranking information is refreshed according to the settlement result. Then, the terminal exits from the interactive interface of the second round and plays an end-of-round animation, and the opponent confrontation mark of the second round disappears from the ranking information.

Operation 602: Enter the preparation phase of the first round.

That is, the terminal starts the preparation phase of the first round. The terminal displays the preparation interface of the first round. The preparation interface includes latest ranking information and an initialized gameboard. In some embodiments, the gameboard includes a confrontation area and a preparation area. In the confrontation area, no chess piece is contained at first. In the preparation area, all owned candidate chess pieces are contained. The preparation interface may be considered as a gameboard or space in the preparation phase.

Operation 603: Determine whether the first round is an opponent round of confrontation between contestants. If yes, operation 604 is entered. If no, the interactive opponent is not displayed, and the process ends.

That is, a game application determines whether the first round is an opponent round at a logic layer. For example, the game application creates a main thread of auto chess, and the main thread is configured for maintaining main service logic of the game. The terminal executes the foregoing determining logic by using the foregoing main thread. For detailed determining logic, refer to operation 302 in the foregoing embodiment. Details are not described again.

Operation 604: Determine an interactive opponent of the first round.

That is, the game application in the terminal requests to match the interactive opponent in the first round at the logic layer. For example, the game application requests to match the interactive opponent from a service logic process on the server side by using the main thread. For a matching manner, refer to operation 302 in the foregoing embodiment. Details are not described again.

Operation 605: Determine whether the preparation interface is an HUD interface at the current moment. If yes, operation 607 is entered. If no, operation 606 is entered.

That is, the game application determines, at the logic layer, whether the preparation interface is an HUD interface that does not include a function pop-up window. For example, the game application executes the foregoing detection logic for the HUD interface by using the main thread. For the detection manner, refer to operation 303 in the foregoing embodiment. Details are not described again.

Operation 606: When the user closes the function pop-up window after completing the function pop-up window operation, and returns to the HUD interface, operation 607 is performed.

Operation 607: A prompt special effect for the interactive opponent pops up in the HUD interface.

For example, the prompt special effect is a spine special effect. The spine special effect pops up at the interactive opponent in the ranking information and disappears after continuous playback duration reaches 2 seconds.

Operation 608: The prompt special effect appears and gradually shrinks, and disappears after the playback duration is reached, and add a confrontation mark in front of the interactive opponent in the ranking information.

For example, the spine special effect pops up at the interactive opponent in the ranking information and gradually shrinks, converges to the interactive opponent, and finally becomes the confrontation mark of the interactive opponent on the left side of the account avatar after playback is completed. The spine special effect represents that a contestant carrying the confrontation mark is an interactive opponent of the first round.

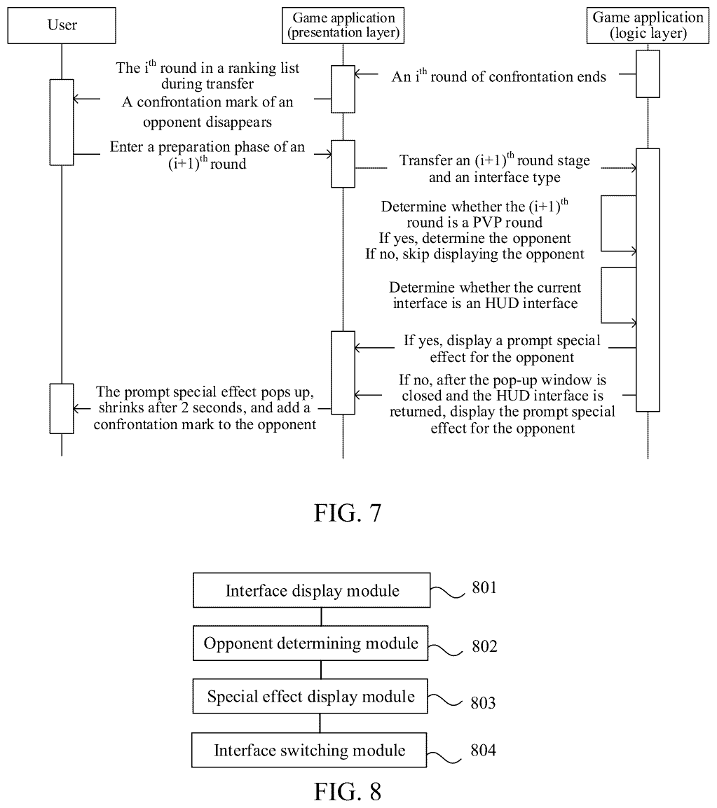

Further, FIG. 7 is a logical flowchart of a prompt special effect display method according to an embodiment of the present disclosure. As shown in FIG. 7, interaction between a user, a game application presentation layer, and a game application logic layer is used for further description. The game application logic layer herein may be provided as a main thread created for a game application. The main thread is configured for maintaining basic main service logic of the game. The game application presentation layer may be provided as a rendering thread created for the game application. The rendering thread is configured for visually drawing an interface on a terminal screen driven by the main thread.

In the following, that the first round is an (i+1)^{th} round is used as an example, i is an integer greater than or equal to 1, and an interaction process of the three is described by using an example. The logic layer determines that an i^{th} round ends and sends an end-of-round instruction to the presentation layer. The presentation layer responds to the end-of-round instruction, exits from an interactive interface of the i^{th} round, and controls to cancel an opponent confrontation mark of the i^{th} round in the ranking list. After entering a preparation phase of the (i+1)^{th} round, the user can choose whether to open a function pop-up window to perform a preparation operation such as store card extraction, talent settings, and equipment adjustment. The presentation layer provides the logic layer with the (i+1)^{th} round stage and an interface type according to the preparation operation of the user at the current moment. The logic layer determines whether the (i+1)^{th} round is a PVP round. If the (i+1)^{th} round is a PVP round, the terminal determines an interactive opponent of the (i+1)^{th} round and enters determining logic of a next HUD interface. If the (i+1)^{th} round is not a PVP round, the terminal does not need to display the interactive opponent and exits the process. The logic layer determines whether the current interface of the (i+1)^{th} round is an HUD interface. If the current interface is an HUD interface, the terminal plays a prompt special effect for the interactive opponent. If the current interface is not an HUD interface, the terminal waits for the user to close all function pop-up windows and return to the HUD interface before playing the prompt special effect for the interactive opponent. The presentation layer controls the prompt special effect to pop up at the interactive opponent in the ranking list. The special effect shrinks after 2 seconds, and a confrontation mark is added around the interactive opponent in the ranking list. Herein, 2 seconds is only an example, and a technical person can replace it with another parameter according to a service requirement.

In the foregoing process, a possible implementation in which the prompt special effect is delayed for playback when the function pop-up window is included is provided. In some embodiments, as described in the foregoing embodiment, even if the preparation interface includes the function pop-up window, it may be further finely detected whether the function pop-up window conflicts with the prompt special effect during display, so as to determine whether the prompt special effect needs to be played in a delayed manner. Details are not described herein.

In the foregoing embodiments, a display process of an exclusive prompt special effect can be given to an interactive opponent in any round of a game match, thereby strengthening the display manner of the interactive opponent in the first round. If a function pop-up window is detected in the preparation interface, the prompt special effect is delayed. The prompt special effect is not displayed until all function pop-up windows in the preparation interface are closed. In this manner, important strategy information of an interactive opponent in any round can be more effectively and interestingly transmitted to the user, so as to improve game experience of the user.

FIG. 8 is a schematic structural diagram of a special effect display apparatus according to an embodiment of the present disclosure. As shown in FIG. 8, the apparatus includes:
an interface display module 801, configured to display a preparation interface of a first round of a game match, multiple contestants in the game match being displayed in the preparation interface;
an opponent determining module 802, configured to determine an interactive opponent of the first round from the multiple contestants in response to the first round being an opponent round, the opponent round being an interactive round between the contestants;
a special effect display module 803, configured to display, in response to that the preparation interface does not contain an obstruction, a prompt special effect for the interactive opponent, the prompt special effect being configured for prompting a user to interact with the interactive opponent in the first round, and the obstruction referring to an interface element capable of shielding the prompt special effect; and
an interface switching module 804, configured to switch from the preparation interface to an observation interface in a second round in response to a trigger operation on the prompt special effect, the observation interface being configured for displaying an interaction behavior of the interactive opponent in the second round.

In the apparatus provided in this embodiment of the present disclosure, in the preparation phase of the opponent round, because both parties involved in the confrontation are contestants of the game match, the terminal first detects whether the preparation interface includes an obstruction. Only in response to that there is no obstruction, the terminal plays a prompt special effect for the interactive opponent, so that a user can quickly enter, by using the prompt special effect, an observation interface in a completed or ongoing round of the interactive opponent. On one hand, this prompt special effect is used for emphasizing the matched interactive opponent. On the other hand, by using detection logic of the obstruction, the user can avoid missing the prompt special effect because the prompt special effect is shielded, and avoid forgetting or missing this very important strategy prompt of the interactive opponent. In a playback process of the prompt special effect, the user can enter the observation interface at any time by using the prompt special effect, thereby shortening an operation link for the user to enter the observation interface, and improving human-computer interaction efficiency.

In some embodiments, ranking information is displayed on the preparation interface, and the ranking information represents rankings of the multiple contestants in the game match. Based on the apparatus shown in FIG. 8, the special effect display module 803 includes: a special effect playback unit, configured to play the prompt special effect based on the ranking information; and a differential display unit, configured to differentially display, after the prompt special effect is completely played, the interactive opponent in the ranking information.

In some embodiments, the prompt special effect includes dynamic and static special effects; and a display size of the dynamic special effect in a playback process gradually shrinks, and the static special effect is configured for differentially displaying the interactive opponent in the ranking information when the dynamic special effect is completely played.

In some embodiments, the interface switching module 804 is further configured to: switch from the preparation interface to the observation interface in response to an operation of triggering the differentially displayed interactive opponent in the ranking information.

In some embodiments, based on the apparatus composition shown in FIG. 8, the apparatus further includes: an interface detection module, configured to detect an interface type of the preparation interface; and the special effect display module 803 is further configured to display the prompt special effect in response to that the interface type is an interactive interface that does not include a function pop-up window.

In some embodiments, the special effect display module 803 is further configured to: display, in response to that the interface type is an interactive interface that includes a function pop-up window, the prompt special effect after it is detected that the function pop-up window is closed.

In some embodiments, the preparation interface displays ranking information of the multiple contestants in the game match, and the special effect display module 803 is further configured to: determine, in response to that the interface type is an interactive interface that includes a function pop-up window, a display area of the prompt special effect based on a location of the interactive opponent in the ranking information; and display the prompt special effect in response to that the function pop-up window and the display area do not overlap each other.

In some embodiments, the special effect display module 803 is further configured to: place, in response to that there is an overlapping area between the function pop-up window and the display area, the prompt special effect on a top layer of the overlapping area if the overlapping area does not include an interactive control in the function pop-up window, and displaying the prompt special effect.

In some embodiments, based on the apparatus composition shown in FIG. 8, the apparatus further includes a special effect generation module, configured to: generate the prompt special effect based on a virtual image of the interactive opponent in the game match; or generate the prompt special effect based on a field object configured by the interactive opponent in the second round; or generate the prompt special effect based on a ranking of the interactive opponent in the ranking information and an account attribute of the interactive opponent.

All the foregoing example technical solutions can be combined in different manners to form other embodiments of the present disclosure, and details are not described herein. When the special effect display apparatus provided in the foregoing embodiment displays the prompt special effect for the interactive opponent, only division of the foregoing functional modules is used as an example for description. In actual application, the foregoing functions can be allocated to different functional modules according to requirements, that is, an internal structure of the electronic device is divided into different functional modules, so as to complete all or some of the functions described above. In addition, the special effect display apparatus provided in the foregoing embodiment and the special effect display method embodiment belong to the same concept. For a specific implementation process of the special effect display apparatus, refer to the special effect display method embodiment. Details are not described herein again.

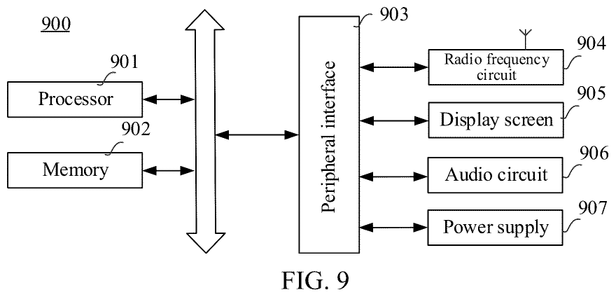

FIG. 9 is a schematic structural diagram of an electronic device according to an embodiment of the present disclosure. As shown in FIG. 9, the electronic device being a terminal 900 is use for description. In some embodiments, a device type of the terminal 900 includes: a smartphone, a tablet computer, a Moving Picture Experts Group Audio Layer III (MP3) player, a Moving Picture Experts Group Audio Layer IV (MP4) player, a laptop computer, or a desktop computer. The terminal 900 may also be referred to as another name such as user equipment, a portable terminal, a laptop terminal, or a desktop terminal.

Generally, the terminal 900 includes: a processor 901 and a memory 902.

In some embodiments, The processor 901 includes one or more processing cores, for example, a 4-core processor or an 8-core processor. In some embodiments, the processor 901 is implemented in at least one hardware form of a digital signal processor (DSP), a field-programmable gate array (FPGA), and a programmable logic array (PLA). In some embodiments, the processor 901 includes a main processor and a coprocessor. The main processor is configured to process data in an active state, also referred to as a central processing unit (CPU). The coprocessor is a low-power processor configured to process data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

In some embodiments, the memory 902 includes one or more computer-readable storage media, and in some embodiments, the computer readable storage medium is non-transitory. In some embodiments, the memory 902 may include a high-speed random access memory (RAM) and a nonvolatile memory, for example, one or more disk storage devices or flash storage devices. In some embodiments, the non-transient computer readable storage medium in the memory 902 is configured to store at least one segment of program code, and the at least one segment of program code is used by the processor 901 to implement the special effect display method provided in the embodiments of the present disclosure.

In some embodiments, the terminal 900 further includes: a peripheral device interface 903 and at least one peripheral device. The processor 901, the memory 902, and the peripheral device interface 903 can be connected by using a bus or a signal cable. Each peripheral device can be connected to the peripheral device interface 903 by using a bus, a signal cable, or a circuit board. Specifically, the peripheral device includes: at least one of a radio frequency circuit 904, a display screen 905, an audio circuit 906, and a power supply 907.

A person skilled in the art can understand that the structure shown in FIG. 9 does not constitute a limitation on the terminal 900, and can include more or fewer components than those shown in the figure, or combine some components, or use different component arrangements.

In an example embodiment, a computer readable storage medium is further provided, for example, a memory including at least one computer program. The at least one computer program may be executed by a processor in an electronic device to complete the special effect display method in the foregoing embodiments. For example, the computer readable storage medium includes a read-only memory (ROM), a random access memory (RAM), a compact disc read-only memory (CD-ROM), a magnetic tape, a floppy disk, and an optical data storage device.

In an example embodiment, a computer program product is further provided, including one or more computer programs stored in a computer readable storage medium. One or more processors of an electronic device can read the one or more computer programs from the computer readable storage medium, and the one or more processors execute the one or more computer programs, so that the electronic device can perform the special effect display method in the foregoing embodiments.

A person of ordinary skill in the art can understand that all or some of the operations of the embodiments may be implemented by hardware or a program instructing relevant hardware. In some embodiments, the program is stored in a computer readable storage medium. In some embodiments, the storage medium mentioned above is a read-only memory, a magnetic disk, an optical disc, or the like.

The foregoing descriptions are merely example embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A special effect display method, performed by an electronic device and comprising:
displaying a preparation interface of a first round of a game match, multiple contestants in the game match being displayed in the preparation interface;
determining an interactive opponent of the first round from the multiple contestants in response to the first round being an opponent round, the opponent round referring to an interactive round between the contestants;
displaying, in response to that the preparation interface does not contain an obstruction, a prompt special effect for the interactive opponent, the prompt special effect being configured for prompting a user to interact with the interactive opponent in the first round, and the obstruction referring to an interface element capable of shielding the prompt special effect; and
switching from the preparation interface to an observation interface of a second round in response to a trigger operation on the prompt special effect, the observation interface being configured for displaying an interaction behavior of the interactive opponent in the second round.

2. The method according to claim 1, wherein ranking information is displayed in the preparation interface, and the ranking information represents rankings of the multiple contestants in the game match; and the displaying a prompt special effect for the interactive opponent comprises:
playing the prompt special effect based on the ranking information; and
differentially displaying, after the prompt special effect is completely played, the interactive opponent in the ranking information.

3. The method according to claim 2, wherein the prompt special effect comprises a dynamic special effect and a static special effect; and a display size of the dynamic special effect in a playback process gradually shrinks, and the static special effect is configured for differentially displaying the interactive opponent in the ranking information when the dynamic special effect is completely played.

4. The method according to claim 2, wherein the method further comprises:
switching from the preparation interface to the observation interface in response to an operation of triggering the differentially displayed interactive opponent in the ranking information.

5. The method according to claim 1, wherein the displaying, in response to that the preparation interface does not contain an obstruction, a prompt special effect for the interactive opponent comprises:
detecting an interface type of the preparation interface; and
displaying the prompt special effect in response to that the interface type is an interactive interface that does not comprise a function pop-up window.

6. The method according to claim 5, wherein the method further comprises:
displaying, in response to that the interface type is an interactive interface that comprises a function pop-up window, the prompt special effect after it is detected that the function pop-up window is closed.

7. The method according to claim 5, wherein the preparation interface displays ranking information of the multiple contestants in the game match, and the method further comprises:
determining, in response to that the interface type is an interactive interface that comprises a function pop-up window, a display area of the prompt special effect based on a location of the interactive opponent in the ranking information; and
displaying the prompt special effect in response to that the function pop-up window and the display area do not overlap each other.

8. The method according to claim 7, wherein the method further comprises:
placing, in response to an overlapping area existing between the function pop-up window and the display area, the prompt special effect on a top layer of the overlapping area if the overlapping area does not comprise an interactive control in the function pop-up window, and displaying the prompt special effect.

9. The method according to claim 1, wherein the method further comprises:
generating the prompt special effect based on a virtual image of the interactive opponent in the game match.

10. The method according to claim 1, further comprising:
generating the prompt special effect based on a field object configured by the interactive opponent in the second round.

11. The method according to claim 1, further comprising:
generating the prompt special effect based on a ranking of the interactive opponent in the ranking information and an account attribute of the interactive opponent.

12. A special effect display apparatus, comprising:
one or more processors and one or more memories, the one or more memories storing at least one computer program, and the at least one computer program being loaded and executed by the one or more processors to implement:
displaying a preparation interface of a first round of a game match, multiple contestants in the game match being displayed in the preparation interface;
determining an interactive opponent of the first round from the multiple contestants in response to the first round being an opponent round, the opponent round referring to an interactive round between the contestants;
displaying, in response to that the preparation interface does not contain an obstruction, a prompt special effect for the interactive opponent, the prompt special effect being configured for prompting a user to interact with the interactive opponent in the first round, and the obstruction referring to an interface element capable of shielding the prompt special effect; and
switching from the preparation interface to an observation interface of a second round in response to a trigger operation on the prompt special effect, the observation interface being configured for displaying an interaction behavior of the interactive opponent in the second round.

13. The apparatus according to claim 1, wherein ranking information is displayed in the preparation interface, and the ranking information represents rankings of the multiple contestants in the game match; and the displaying a prompt special effect for the interactive opponent comprises:
playing the prompt special effect based on the ranking information; and
differentially displaying, after the prompt special effect is completely played, the interactive opponent in the ranking information.

14. The apparatus according to claim 13, wherein the prompt special effect comprises a dynamic special effect and a static special effect; and a display size of the dynamic special effect in a playback process gradually shrinks, and the static special effect is configured for differentially displaying the interactive opponent in the ranking information when the dynamic special effect is completely played.

15. The apparatus according to claim 13, wherein the one or more processors are further configured to implement:
switching from the preparation interface to the observation interface in response to an operation of triggering the differentially displayed interactive opponent in the ranking information.

16. The apparatus according to claim 12, wherein the displaying, in response to that the preparation interface does not contain an obstruction, a prompt special effect for the interactive opponent comprises:
detecting an interface type of the preparation interface; and
displaying the prompt special effect in response to that the interface type is an interactive interface that does not comprise a function pop-up window.

17. The apparatus according to claim 16, wherein the one or more processors are further configured to implement:
displaying, in response to that the interface type is an interactive interface that comprises a function pop-up window, the prompt special effect after it is detected that the function pop-up window is closed.

18. The apparatus according to claim 16, wherein the preparation interface displays ranking information of the multiple contestants in the game match, and the one or more processors are further configured to implement:
determining, in response to that the interface type is an interactive interface that comprises a function pop-up window, a display area of the prompt special effect based on a location of the interactive opponent in the ranking information; and
displaying the prompt special effect in response to that the function pop-up window and the display area do not overlap each other.

19. The apparatus according to claim 18, wherein the one or more processors are further configured to implement:
placing, in response to an overlapping area existing between the function pop-up window and the display area, the prompt special effect on a top layer of the overlapping area if the overlapping area does not comprise an interactive control in the function pop-up window, and displaying the prompt special effect.

20. A non-transitory computer readable storage medium, having at least one computer program stored therein, the at least one computer program being loaded and executed by a processor to implement:
displaying a preparation interface of a first round of a game match, multiple contestants in the game match being displayed in the preparation interface;
determining an interactive opponent of the first round from the multiple contestants in response to the first round being an opponent round, the opponent round referring to an interactive round between the contestants;
displaying, in response to that the preparation interface does not contain an obstruction, a prompt special effect for the interactive opponent, the prompt special effect being configured for prompting a user to interact with the interactive opponent in the first round, and the obstruction referring to an interface element capable of shielding the prompt special effect; and
switching from the preparation interface to an observation interface of a second round in response to a trigger operation on the prompt special effect, the observation interface being configured for displaying an interaction behavior of the interactive opponent in the second round.
